(19) United States
(12) Patent Application Publication
(10) Pub. No.: US 2018/0326846 A1
(43) Pub. Date: Nov. 15, 2018

(54) DIFFERENTIAL SYSTEM THAT CONTROLS THE TRACTION OF THE WHEELS OF A VEHICLE

(71) Applicant: Servando Soto Velasco, Tlajomulco de Zúñiga, Jalisco (MX)

(72) Inventor: Servando Soto Velasco, Tlajomulco de Zúñiga, Jalisco (MX)

(21) Appl. No.: 15/773,481

(22) PCT Filed: Nov. 3, 2015
(86) PCT No.: PCT/MX2015/000143

§ 371 Date: May 3, 2018

(51) Int. Cl. B60K 23/04; B60K 17/342; B60K 17/16; F16H 48/34

(52) U.S. Cl. CPC B60K 23/04; B60K 17/342; F16H 48/40; F16H 48/34; B60K 17/16

(57) ABSTRACT

The invention consists of a differential system which controls the traction of at least four wheels of a vehicle, and includes: a differential mechanism (1) connected to the free extremities of the axles (3 or 6) of the wheels (4 or 7) of the vehicle; this provides at least one mechanism of power transmission for each side of the differential mechanism (1), where the driving element (8) connects to the axle (3 or 6) to which the differential mechanism is connected (1) and the driven element (10) to the axle without differential mechanism (1), of the wheels (4 and 7) of the same side of the vehicle, in order to transmit power to the said wheels through the transmission system (9); a freewheel unit (5) is placed on the trajectory of the power transmission which goes from the differential mechanism (1) to its respective front wheel (7); and at least one braking mechanism for braking the wheels of the vehicle.

### TECHNICAL FIELD OF THE INVENTION

This invention is related to the mechanical and automotive technical fields since it concerns a differential system that controls the traction of at least the four wheels of a vehicle.

### BACKGROUND OF THE INVENTION

Differential mechanisms derived from the need to be able to have the wheels of a vehicle turn at a different speed while the vehicle is moving along a curve, and have the said wheels turn at the same speed while the vehicle is moving along a straight line.

The conventional open differential mechanism solved this problem by being initially installed in the forward axle of the vehicle. Subsequently the differential was installed also in the rear axle and later also in a central axle, located between the forward and rear axles. In this way, once all the 3 above mentioned differential mechanisms were installed in the vehicle the result was permanent traction on its 4 wheels, providing permanent traction in its 4 wheels and allowing the vehicle to circulate on surfaces of both low or high adherence.

Subsequently the problem arose that although a vehicle would have 1, 2 or 3 differential mechanisms, if a wheel of the said vehicle skidded then the vehicle would lose traction and would no longer move forward, due to the fact that all of its force would be directed to the skidding wheel; in order to solve this problem differential systems with locking planetary mechanisms were devised, as well as self-locking differential mechanisms which partially or completely solve the problem of losing the entire force of the vehicle on the skidding wheel. However, these systems generate other problems, especially concerning maneuverability and steering. Furthermore, they are not as efficient as desired since the differential mechanisms that lock their planetary gears have the disadvantage of having the 2 wheels of the vehicle to which the force is directed spinning at the same speed, which means that under these conditions the vehicle should only move on low adherence surfaces in order to avoid damaging its power transmission system and to prevent premature wear of tires; additionally, self-locking differential mechanisms have the drawback in some cases of having a slow response, in others of working only when it is detected that a wheel is skidding at a certain speed in relation to the opposite wheel, and in others yet of saving only a small percentage of the force which is lost by the skidding wheel. Finally, most of these systems are based on friction, which represents a loss of energy.

In order to enhance their efficiency, the said differential mechanisms were combined with electronic or hydraulic systems and/or sensors, among others, which resulted in faster response times and a more controlled performance, yet these systems also have drawbacks, such as a higher cost, being heavier and more prone to malfunctions as a consequence of having more parts, components, mechanisms and/or systems; in addition to the fact that these systems also use friction, whether for stopping a wheel of the vehicle or a component of the differential mechanisms, which also results in a loss of energy.

Another of the main problems concerning the above-mentioned conventional differential mechanisms is that in order for them to provide traction to all 4 wheels at least 2 or 3 have to be installed, which results in higher cost and weight.

The technologies mentioned below present some examples of traction systems that control the wheels of a vehicle which include conventional differential mechanisms and a power transmission mechanism:

Patent document U.S. Pat. No. 834,008 describes a vehicle with a combination of two pairs of traction wheels, a chassis which supports an energy supply element, a sectional axle for each pair of wheels supported by the chassis, components for connecting the said sectional axle to the wheels in order to make them turn; a differential mechanism belonging to a pair of wheels and power transmission devices for carrying it between the sectional axles.

Patent document MXPA00005686 describes a system for controlling the transfer of torque in a vehicle that includes a transfer enclosure, as well as an anterior and posterior differential unit. In this system the transfer enclosure automatically transfers the torque between the differential units, while the differential units transfer the torque to their respective wheels; under extreme conditions the system supplies the entire torque to a single traction wheel.

Patent document MX2013011507 refers to a differential mechanism that controls the 4 wheels of a vehicle. This is a more complex mechanism which also has the inconvenient that when the vehicle travels along a curve the said differential mechanism accelerates the front wheel located on the open side of the curve, this results in premature wear of the front tires. Additionally, the power transmission system is subjected to a greater effort and thus this differential mechanism is not suitable for vehicles which usually circulate on highly adherent surfaces.

Patent document U.S. Pat. No. 2,514,071 refers to 3 differential mechanism which work together for transmitting force to the 4 wheels of the vehicle. The problem with this system, in addition to the fact that it is composed of 3 differentials, which results in a higher weight and cost than having a single differential, is that when the front right and rear left wheels, or the front left and rear right wheels skid, the vehicle loses traction.

As for patent document WO8802829 A1, it describes a self-locking differential mechanism which is sensitive to torque known as “Torsen”, which attempts to prevent at all times sudden changes in force and spin velocity, preferably between 2 wheels or between 2 axles of a vehicle. This system has the disadvantage that with the resistance and friction it uses in order to prevent a wheel from spinning out of control, the ratio of force and spin velocity in each wheel or axle is not an optimal ratio, in other words, when a wheel skids the vehicle does not lose all of its traction, but it does lose an important amount of force over the skidding wheel. Additionally, the system generates a constant loss of energy when the vehicle is travelling along a curve, even when none of its wheels are skidding.

Patent document US2010063701 presents a self-locking differential with a viscous coupling device which can link the front and rear axles of a vehicle, providing traction on all 4 wheels. The disadvantage of this system is that the time of response for coupling the said axles is slow and in certain circumstances is not capable of transmitting the necessary force to the axle which has the better traction, resulting in the loss of traction.

For this reason, in order to counter the above-mentioned issues, a differential system was developed that controls the traction of at least the four wheels of a vehicle, depending on the conditions and circumstances of the road on which it is travelling, allowing the vehicle to circulate on surfaces with either low or high adherence without having to change its traction as it is normally done from “4×2” to “4×4” and vice versa; a system which works as a self-locking differential mechanism with an almost immediate time of response, without having to brake any of the wheels of the vehicle or any component of the differential system, which is useful in preventing loss of energy due to friction generated by the brakes; can help the vehicle make tighter turns than usual, allows the vehicle to take a turn at a higher speed with elements that help the driver to reduce the possibility of an understeer, which can be configured so that the vehicle can turn without displacement and which additionally includes several forms of power transmission to the wheels of the vehicle.

### BRIEF DESCRIPTION OF THE FIGURES

FIG. 1 is a conventional perspective view of this invention as it appears when assembled, and which consists of a differential system that controls the traction of at least the four wheels of a vehicle.

FIG. 2 is an exploded view of the differential system presented in FIG. 1.

FIG. 3 is a conventional perspective view of the differential system in question, in one of its versions with locking mechanisms of the freewheel units and with switches.

FIG. 4 is a conventional perspective view of the differential system in question, in which one of the versions of the said differential system can be observed including an added mechanism for inverting the spin of the wheels on one side of the vehicle as opposed to those on the other side. This spin inversion is a front differential mechanism.

FIG. 5 is a conventional perspective view of version of the differential system which appears in the previous Figure, in which the front differential mechanism is modified.

FIG. 6 is a view from above of the differential system in question, in the version which appears in the previous Figure, which shows the added mechanisms for locking the freewheel units.

FIG. 7 is a conventional perspective view of version of the differential system which appears in FIG. 5, showing an additional variation of the brake of the satellite and planetary gearbox of the second differential mechanism.

FIG. 8 is a view from above of the differential system which is the object of this invention, in the version presented in the previous Figure, in which a variation of the transmission of force from the motor of the vehicle to the second differential mechanism can be observed.

FIG. 9 is a view from above of the said differential system, in which an additional version of the mechanism for inverting the spin of the wheels, consisting in a transfer case, can be observed.

FIG. 10 is a view from above of the differential system, in which a version of the transfer case can be observed.

FIG. 11 is a conventional perspective view of the selector system for the freewheels as it appears when assembled.

FIG. 12 is a longitudinal section of the selector mechanism, so as to see in more detail the way its parts are assembled.

FIG. 13 is an exploded view of the selector mechanism which selects one freewheel or another.

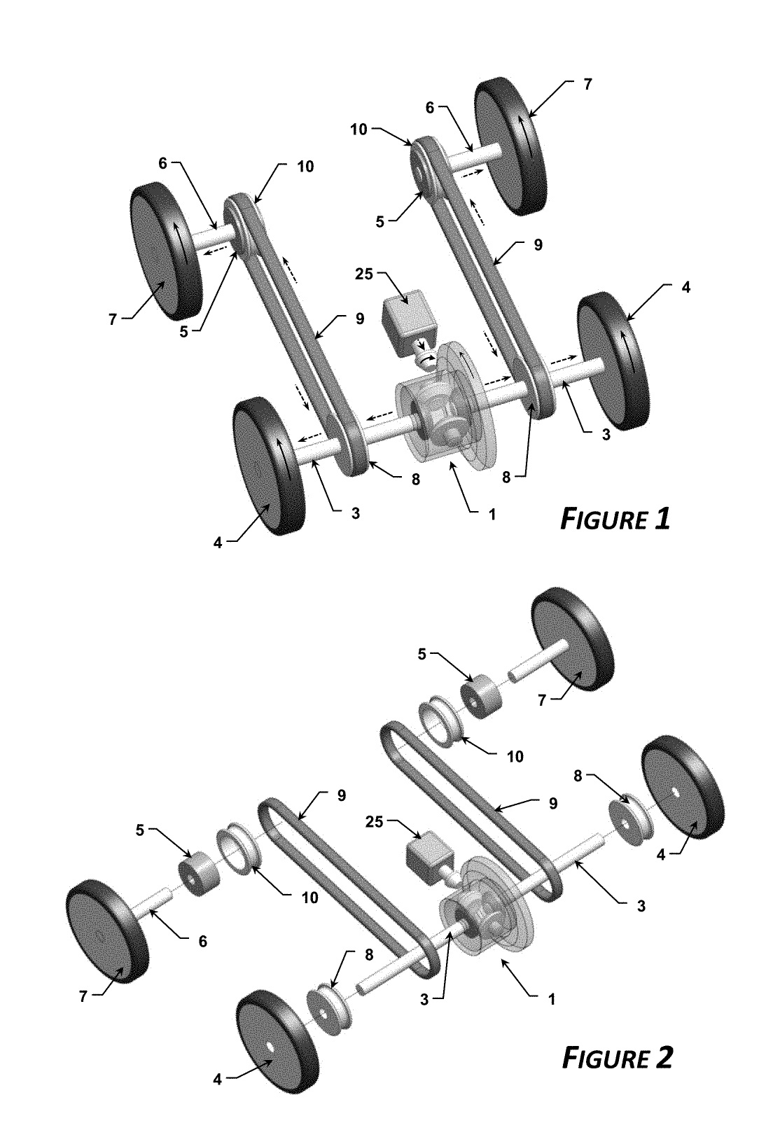

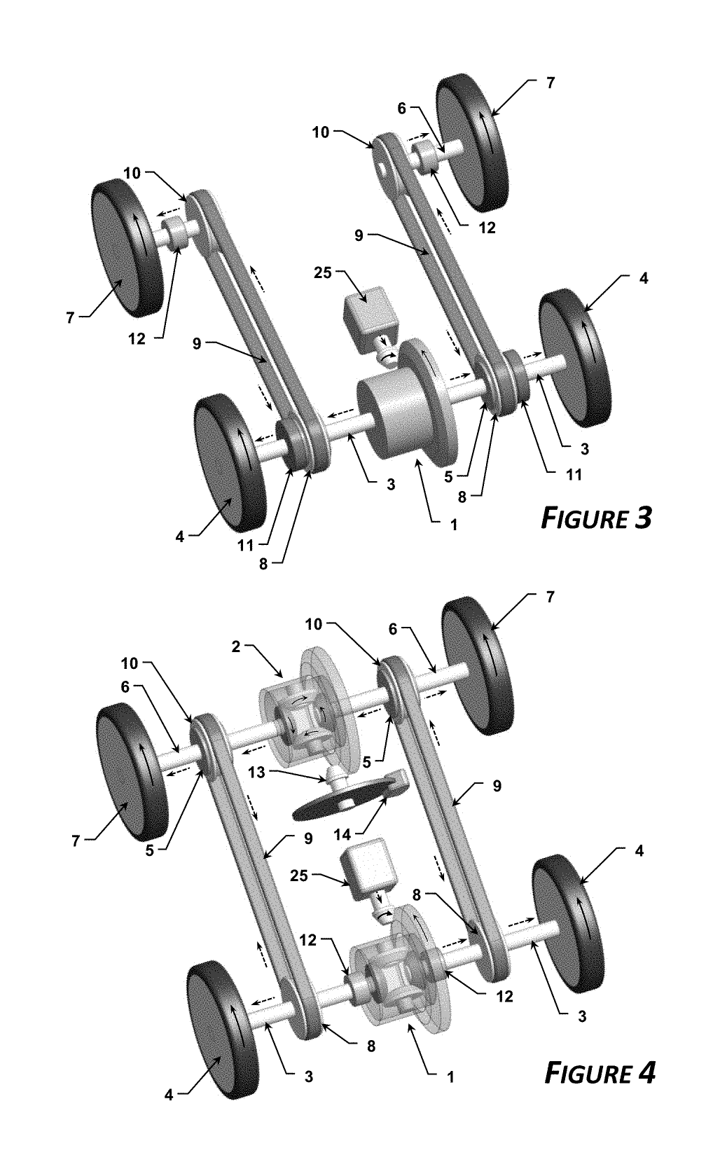

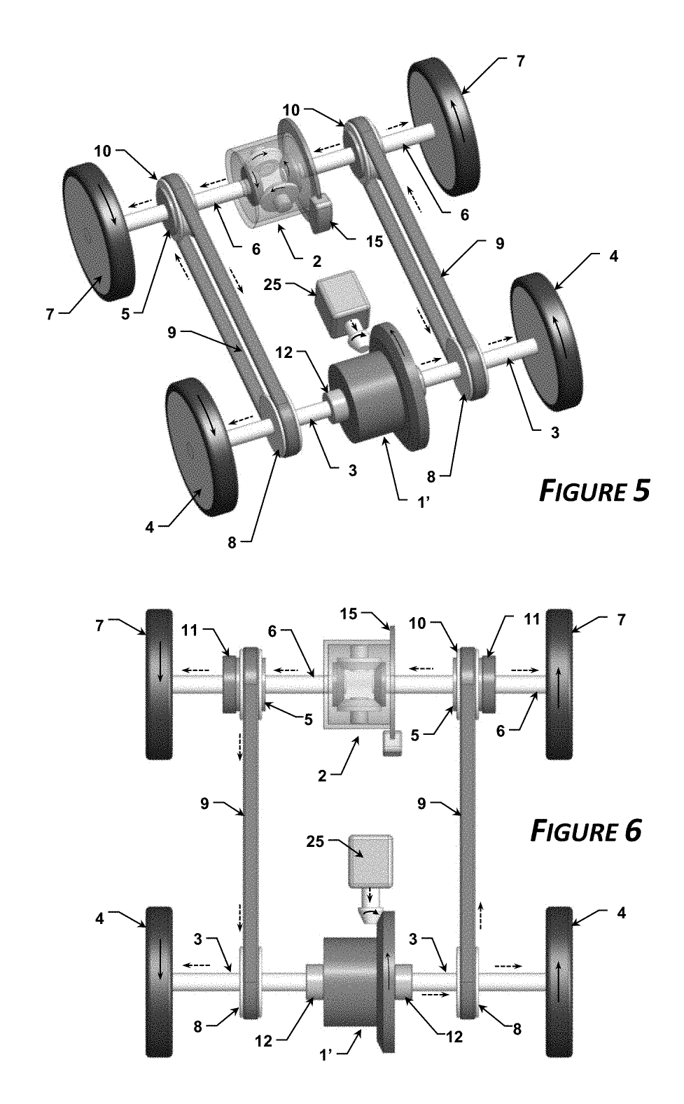

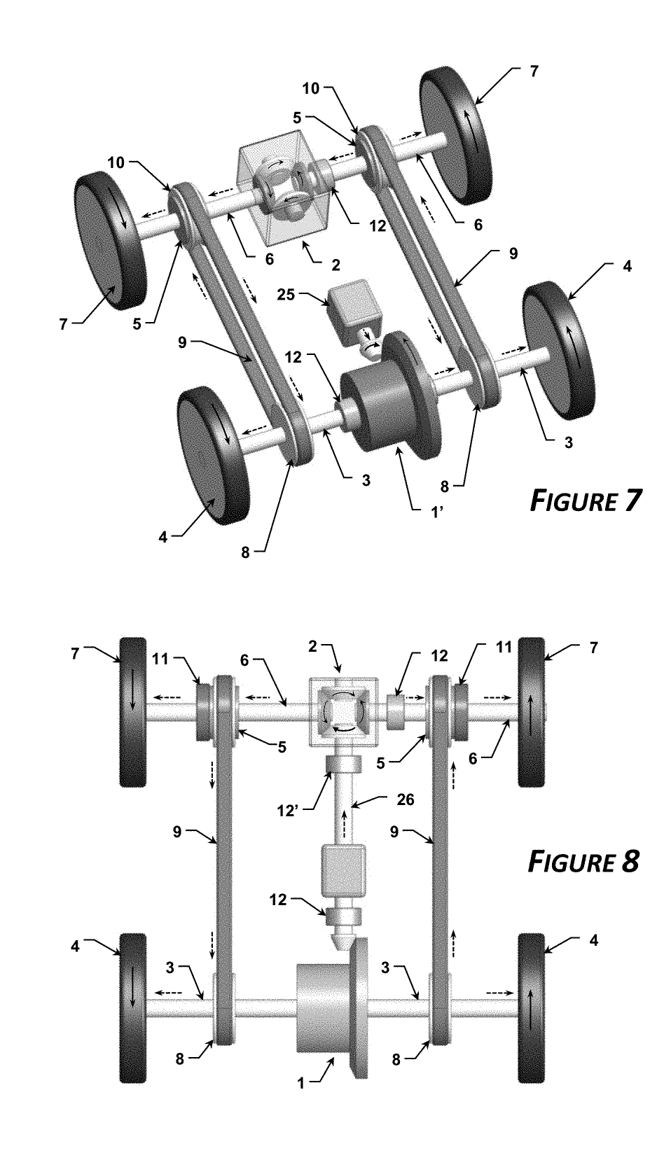

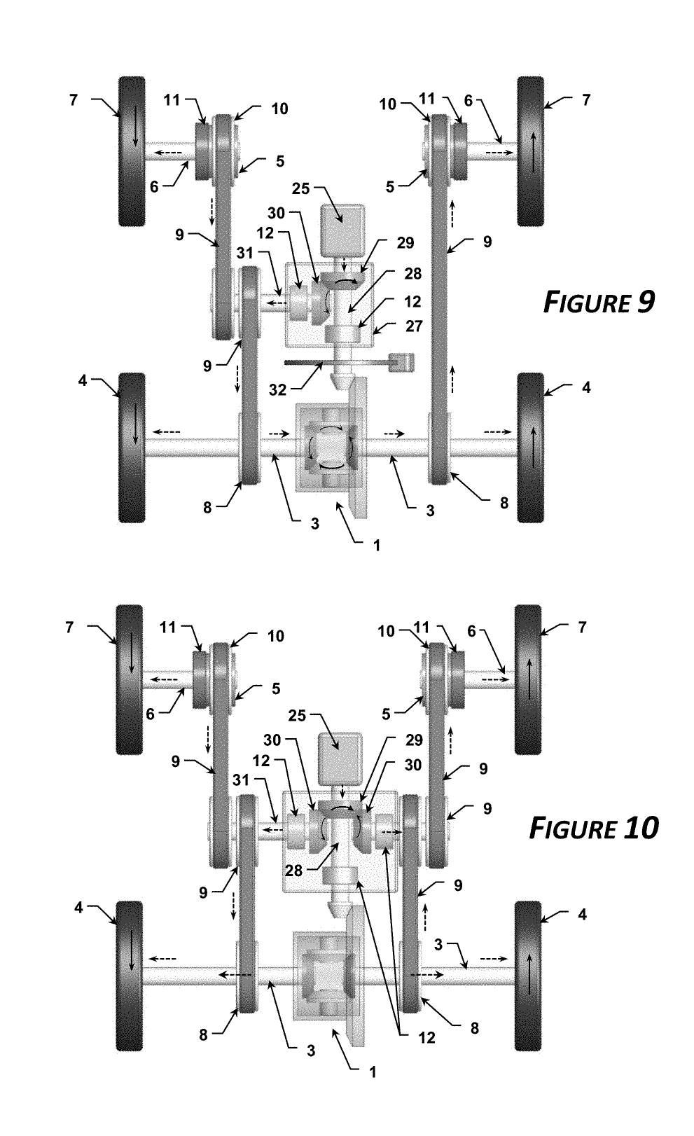

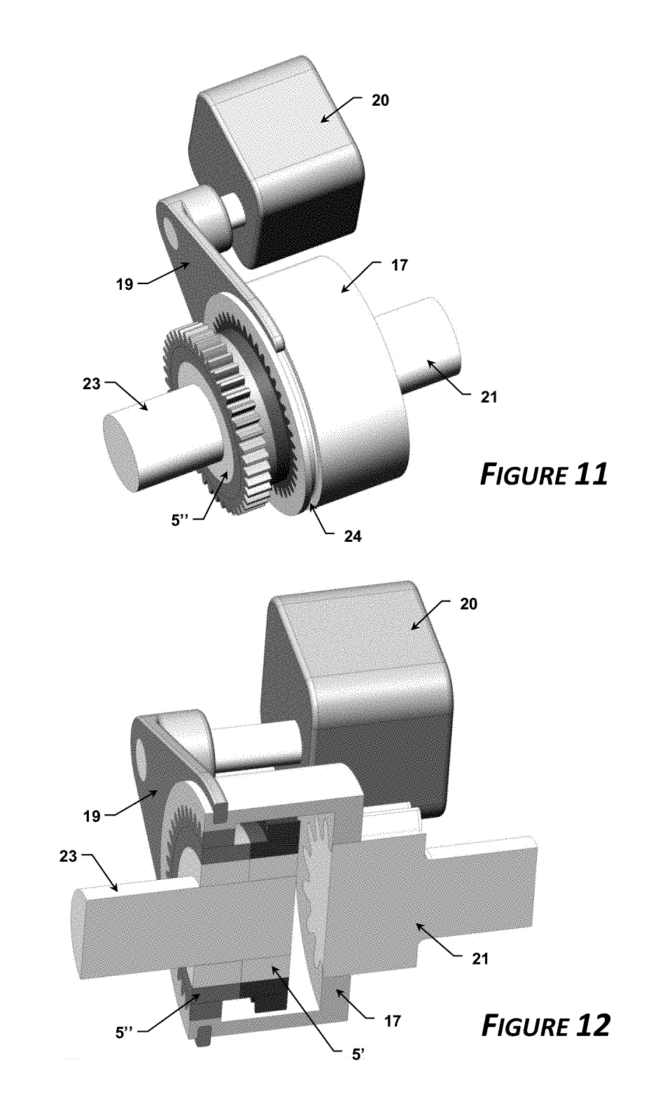

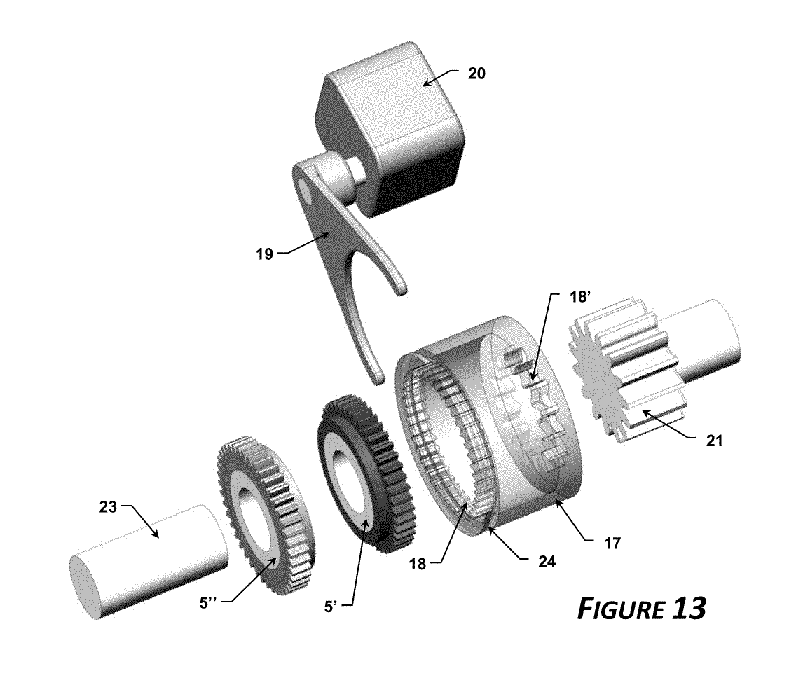

### DETAILED DESCRIPTION OF THE INVENTION

The invention in question regards a differential system that controls the traction of the wheels of a vehicle, specifically vehicles which have at least four wheels.

Below are described some of the realizations of the said invention, together with the figures mentioned above. These realizations are to be taken by way of example and should therefore not be construed as a limitation of the invention in question.

The differential system that controls the traction of at least the four wheels of a vehicle, which is the object of this invention, consists in a first differential mechanism (1) which can be connected between the free extremities of the axles (3 or 6) of the wheels (4 or 7) of the vehicle; where the free extremities of the axles (3 or 6) connect to the planetary gears of the said differential mechanism (1).

A preferred method is to mount the differential mechanism (1) between the free extremities of the axles (3) of the rear wheels (4) of the vehicle.

The first differential mechanism (1) can be: an open differential mechanism, a self-locking differential mechanism, or a manual and/or automatically locking differential mechanism. The self-locking differential mechanism in turn can be: a limited-slip differential (Viscous or Ferguson and mechanical self-locking); a torque-sensitive differential (Torsen); or a controlled-slip differential (multi-plate clutch).

At least one power transmission mechanism is provided for each side of the first differential mechanism (1); where the driving element (8) of the power transmission mechanism connects to the corresponding axle (3 or 6) linked to the differential mechanism (1) in order to provide the said driving element (8) with driving movement; and the driven element (10) of the power transmission mechanism connects to the axle without differential mechanism (1) of the wheels (4 and 7) of the same side in order to transmit the power to those wheels, through the transmission medium (9) of the said power transmission mechanism.

A preferred variation of the invention in question is that the driving (8) and driven (10) elements of the power transmission mechanism are: indented wheels, gears, pinions and/or pulleys; and the transmission medium (9) is selected from the following group: indented wheels, gearset, driveshafts, axles, pinions, chains, pulleys, belts, straps, mechanical joints, mechanical ball joints and/or articulated joints.

The differential system of this invention includes a freewheel unit (5) placed in the trajectory of the power transmission that goes from the differential mechanism (1) toward its corresponding front wheel (7). This freewheel unit (5) can include, at least, a freewheel, depending on the required torque and/or its performance.

It is worth mentioning that for the purposes of this invention, the term “freewheel” refers to any mechanism that allows an axle, part, component, mechanism and/or device to spin freely in one direction and to be geared, assembled, coupled and/or joined when spinning in the opposite direction, such as, for example: a clutch bearing, a free pinion, a freewheel, an indented freewheel, among others.

Another realization of the invention consists in the fact that the driving element (8), the driven element (10) and/or the transmission medium (9), all have different diameters so as to reduce the spin velocity of the force as it enters the freewheel unit (5), with respect to the spin velocity of the force as it leaves the said freewheel unit (5).

An additional modality of the invention in question is that the freewheel unit includes: at least, a freewheel (5′) for transmitting force as the vehicle moves forward; at least, a freewheel (5″) that transmits the force when the vehicle moves backwards; and a selector mechanism which select one or another of the freewheels (5′ or 5″), depending on the direction in which the vehicle is moving. Where the said freewheels (5′ and 5″) have an indented exterior surface.

An innovation of the selector mechanism is that it is composed by: a sliding coupler (17) that has an internal and/or external adaptor (18′) on one of its extremities which houses a medium for the entrance or exit of force (21); another extremity indented on the inside (18), to which is coupled the exterior surface of one or another of the freewheels (5′ or 5″), which are mounted on a force input or output axle (23); and an external duct (24), located preferably on one of its extremities; a control arm (19) that is inserted in the external duct (24) of the coupler (17) in order to move it from one freewheel to another (5′ or 5″); and a driving medium (20) for moving the control arm (19).

The internal and/or external adaptation (18′) can be, at least: an indented surface, a groove, a plane and/or a protrusion, among others.

It is worth mentioning that the medium for displacing the control arm is a device which is: mechanical, electrical, electronic, pneumatic, hydraulic, electromagnetic, etc.; and/or the combinations between them.

The force input or output medium (21) of the selector mechanism can consist of a pinion mounted on an axle that transmits the force; and in which the medium for displacing the control arm (19) can be a device which is: mechanical, electrical, electronic, pneumatic, hydraulic, electromagnetic, and so on.

The differential system that controls the traction of at least the four wheels of a vehicle also includes, at least, a braking system for braking the wheels of the vehicle. This braking system is selected from the following group: a brake that brakes the four wheels (4 and 7) at the same time; a brake that brakes the two front wheels (7) at the same time; a brake that brakes the two rear wheels (4) at the same time; a brake that brakes each front wheel (7) independently; a brake that brakes each rear wheel (4) independently; and/or the combinations between them; in which the said braking system can be operated with a pedal, a handle and/or the turn of the steering wheel of the vehicle.

Another innovation of the differential system of the invention in question consists in the fact that it includes as well a locking and unlocking mechanism (11) on each freewheel unit (5), for locking or unlocking it; this locking and unlocking mechanism (11) can be: a brake, a clutch, or a device which is: mechanical, electrical, electronic, pneumatic, hydraulic, electromagnetic, etc.; and/or the combinations between them.

Another innovation of this invention consists in the fact that the power transmission mechanism includes a switch (12) for connecting and disconnecting the transmission of force directed to its corresponding front wheel (7); this switch (12) can be: a clutch, a mechanism for disconnecting axles; and/or components of the power transmission mechanism.

Another realization of the differential system in this invention is when the first differential mechanism (1) is a differential mechanism which is lockable both manually and automatically; especially when it is an open differential mechanism with a mechanism for locking and unlocking its planetary gears (1′). This first open and lockable differential mechanism (1′), includes as well a switch (12) placed on at least one of its planetary gears, in order to connect and disconnect the transmission of force of the said planetary. This is with the purpose of allowing the differential system of this invention to incorporate a mechanism for inverting the spin of the wheels (4 y 7) on one side, with respect to the wheels (4 y 7) on the other side. This mechanism for inverting the spin of the wheels can be a second differential mechanism or a transfer case.

A brake is included as well for braking at least one of the components of the said mechanism that inverts the spin of the wheels.

A feature of this invention consists in the fact that the second differential mechanism is an open differential mechanism (2), whose force input takes place through one of its planetary gears and force output through the other planetary, and is mounted between the free axles (6) of the front wheels (7) of the vehicle; and the brake for blocking the pinion (13) of the said open differential mechanism (2), is preferably a disc brake (14).

Another feature of this invention consists in the fact that the crown and pinion of the front open differential mechanism (2) are removed, and the brake for braking the satellite gearbox of the said front open differential (2) is: a disc brake (15).

Another feature of this invention consists in the fact that the crown and pinion of the front open differential mechanism (2) are removed and a switch (12) is connected to one of the sides of the said front differential mechanism (2), in order to connect and disconnect its transmission of force, when its satellite gearbox is stationary.

Another innovative feature of this invention is that the differential system includes as well: an axle (26) for transmitting the force from the motor (25) of the vehicle to a satellite of the front open differential mechanism (2); a first switch (12) for connecting and disconnecting the transmission of force that goes from the motor (25) to the first differential mechanism (1), in this case the first differential mechanism (1) has no switches (12) on its sides; and a second switch (12′) for connecting and disconnecting the transmission of force that goes from the motor (25) to the front open differential mechanism (2).

An example of the realization of the transfer case is when it includes: a longitudinal axle (28) that transmits the force of the motor (25) of the vehicle toward the first differential mechanism (1); at least a first conical gear (29) that is inserted axially to the longitudinal axle (28); at least a second conical gear (30) that connects perpendicularly to the first conical gear (29); a transverse axle (31) that supports the second conical gear (30), in which the said transverse axle is connected to its corresponding power transmission mechanism and is supported on the side walls (27) of the transfer case; a switch (12) placed on the transverse axle (31), for connecting and disconnecting the transmission of force directed to its corresponding power transmission mechanism; and another switch (12) placed on at least one of the components that transmit the force that goes from the first conical gear (29) to the first differential mechanism (1).

An additional feature of the differential system is that it includes a brake (32) placed on at least one of the components that transmit the force going from the last above-mentioned switch (12) to the first differential mechanism (1).

The invention therefore also refers to a vehicle that includes a differential system that controls the transmission of at least the four wheels of a vehicle, in accordance with the differential system described in this invention. This vehicle can be a car, an all-terrain vehicle, a utility vehicle, a cargo transport vehicle, or machinery with 4 or more wheels, among others.

With the simple fact of adding a freewheel unit (5) on each side of a differential system, the advantage is obtained of transforming the conventional differential system into a self-locking system and thus making it possible for the vehicle to circulate with a better degree of traction on surfaces of medium and low adherence, such as: dirt roads, mud, sludge, loose gravel, sand, wet pavement, snow, etc.; considering that one of the main advantages of the differential system in question consists in the fact that it allows the vehicle to circulate with traction on its 4 wheels on surfaces with high adherence, such as dry pavement, without the need to change from traction on its 4 wheels (performing as 4×4) to traction on its 2 rear wheels (performing as 4×2) and vice versa, as is usually the case with vehicles today. In addition to the fact that in this way the vehicle gains maneuverability, has better steering and is capable of taking tighter turns, considerably reducing the effort and excessive wear of both the tires and the transmission system, as is usually the case with vehicles that have a positive differential mechanism between the axles of their rear wheels which make the rear wheels to spin always at the same speed and in the same direction, as in the vast majority of current ATV (All Terrain Vehicle) and UTV (Utility Task Vehicle) vehicles, as well as in vehicles which do not have a central differential mechanism central and have traction activated on all four wheels.

The differential system of the invention in question has the above-mentioned self-locking mechanism since while the vehicle is moving in a straight line it will normally have traction on all four of its wheels (performing as 4×4); when the vehicle circulates on a curve, it will normally have traction on its two rear wheels (performing as 4×2), allowing the two front wheels to spin freely depending on how many spins each front wheel needs to take; and when any or both of the rear wheels of the vehicle lose traction, at that moment, in a mechanical and automatic way through the freewheel units (5), traction is transmitted to the respective front wheel or wheels of the vehicle (performing as 4×3 or 4×4), thus self-locking the out of control spin of the rear wheels that have lost traction.

The differential system of this invention provides the vehicle with traction at least on two of its wheels (performing as 4×2 in three different ways), either on its two rear wheels, on the two wheels on the left side, or on the two wheels on the right side; usually it will be the two rear wheels to have traction.

It is important to mention that the differential system of the invention provides the user with greater and better control of the vehicle, since by having brakes that operate independently on at least two of the wheels, the vehicle can turn by pivoting on the wheel that is braking, therefore when the brakes are used independently, in addition to braking the vehicle, they function as “Directional Brakes” with which it is possible to give considerably tighter turns than usual, and which reduce the possibility of an “understeer”, depending however on the driving skills of the user.

Another of the main advantages of the differential system in question consists in the fact that it provides the user with “Total Control” of his vehicle, since in addition to driving, maneuvering, accelerating and/or braking his vehicle, he also has control on the distribution of the force being sent to all the wheels of the vehicle, in other words the user can decide at any moment to which wheels he wishes to transmit the force to, whether he transmits the force: only to the rear wheels, partially or totally to the wheels on the left side of the vehicle, partially or totally to the wheels on the right side of the vehicle, or to the all four wheels at the same time; or that when the force is transmitted mechanically and automatically to the rear wheels, force is also transmitted to the corresponding front wheel of the rear wheel or wheels that lose traction; the user can also decide whether the wheels on the left side of the vehicle spin in the opposite direction and at the same or different speed than the wheels of the right side of the vehicle; or if each rear wheel spins at the same or at a different speed than its corresponding front wheel; depending on how the differential system of the invention is configured.

1. A differential system that controls the traction of at least the four wheels of a vehicle, comprising:
a first differential mechanism connected between free extremities of each axle of the wheels of the vehicle in which the free extremities of the axles are connected to planetary gears of the differential mechanism;
at least a power transmission mechanism is provided for each side of the differential mechanism; in which the driving element of the power transmission mechanism is connected to the axle that is connected to the differential mechanism and the driven element to the axle without differential mechanism, of the wheels on one side of the vehicle, in order to transmit force to the said wheels through the transmission medium of the said power transmission mechanism;
a freewheel unit is placed on every power transmission trajectory going from the differential mechanism toward its corresponding front wheel; and
at least one braking system for braking the wheels of the vehicle.

2. The system of claim 1, wherein the first differential mechanism is mounted between the free extremities of the axles of the rear wheels.

3. The system in accordance with claim 1, wherein the first differential mechanism is: an open differential mechanism, a self-locking differential mechanism, or a manual and/or automatically locking differential mechanism.

4. The system of claim 3, wherein the self-locking differential mechanism is: a limited-slip differential (Viscous or Ferguson and mechanical self-locking); a torque-sensitive differential (Torsen); or a controlled-slip differential (multi-plate clutch).

5. The system in accordance with claim 1, wherein the driving element and driven element of the power transmission mechanism are: indented wheels, gears, pinions and/or pulleys; and the transmission medium is selected from the following group: indented wheels, gearset, driveshafts, axles, pinions, chains, pulleys, belts, straps, mechanical joints, mechanical ball joints and/or articulated joints.

6. The system of claim 1, wherein the driving element, the driven element and/or the transmission medium, have different diameters, in order to reduce the spin velocity of the force input of the freewheel unit, relative to the spin velocity of the force output of the said freewheel unit.

7. The system as claimed in claim 1, wherein the freewheel unit includes at least a free wheel, depending on the required torque and/or its operation.

8. The system of claim 7, wherein the freewheel unit comprising:
at least a free wheel which transmits the force when the vehicle moves forward;
at least a free wheel which transmits the force when the vehicle moves backward; and
a selector mechanism which selects one or another free wheel, depending on the direction in which the vehicle is moving.

9. The system of claim 8, wherein the free wheels have an indented exterior surface.

10. The system of claim 8, wherein the selector mechanism, comprising:
a sliding coupler which has on one of its extremities an interior and/or exterior adaptation, which houses a force input or output medium; another internally indented extremity, onto which the exterior indented surface of one or another free wheel is coupled, which are mounted onto a force input or output axle; and an external duct;
a control arm inserted onto the external duct of the coupler in order to move it from one to another of the free wheels; and
a driving medium for moving the control arm.

11. The system of claim 10, wherein the interior and/or exterior adaptor is, at least: a dented surface, a slot, a plane and/or a protrusion.

12. The system of claim 10, wherein the medium for moving the control arm is a device that is: mechanical, electrical, electronic, pneumatic, hydraulic, electromagnetic, and/or the combinations between them.

13. The system in accordance with claim 1, wherein the braking system is selected from the following group: a brake that brakes the four wheels at the same time; a brake that brakes the two front wheels at the same time; a brake that brakes the two rear wheels at the same time; a brake that brakes each front wheel independently; a brake that brakes each rear wheel independently; and/or the combinations between them; in which the said braking system can be operated with a pedal, a handle and/or by turning of the steering wheel of the vehicle.

14. The system in accordance with claim 1, further comprising an additional locking and unlocking mechanism for each freewheel unit, for the purpose of locking or unlocking it.

15. The system in accordance with claim 14, wherein the locking mechanism can be: a brake, a clutch, or a device which is: mechanical, electrical, electronic, pneumatic, hydraulic, electromagnetic, and/or the combinations between them.

16. The system in accordance with claim 1, wherein the power transmission mechanism includes a switch for connecting and disconnecting the transmission of force directed to its corresponding front wheel.

17. The system of claim 16, wherein the switch is: a clutch; an axle-disconnecting mechanism; and/or components of the power transmission mechanism.

18. The system in accordance with claim 3, wherein the first differential mechanism, is an open differential mechanism that can be locked either manually or automatically, with a mechanism for locking or unlocking its planetary gears.

19. The system of claim 18, wherein the first open locking differential mechanism, includes as well a switch placed on at least one of its planetary gears, in order to connect or disconnect the power transmission of the said planetary gears.

20. The system in accordance with claim 18, comprising:
a mechanism for inverting the spin of the wheels (4 and 7) on one side of the vehicle, relative to the wheels (4 and 7) of the other side of the vehicle; and
a brake for braking at least one component of the said mechanism which inverts the spin of the wheels.

21. The system in accordance with claim 20, wherein the mechanism for inverting the spin of the wheels is a second differential mechanism.

22. The system in accordance with claim 21, wherein the second differential mechanism is a front open differential mechanism, whose force input is through one of its planetary gears and its force output is through the other planetary, and is mounted between the free axles of the front wheels of the vehicle; and the brake for braking the pinion of the said front open differential mechanism, is a disc brake.

23. The system in accordance with claim 22, wherein the crown and the pinion of the front open differential mechanism are removed and the brake for braking the satellite gearbox of the said front open differential mechanism is: a disc brake.

24. The system of claim 22, wherein the crown and the pinion of the front open differential mechanism are removed, and a switch is connected to one of the sides of the said front differential mechanism, in order to connect and disconnect its transmission of force when its satellite gearbox is stationary.

25. The system of claim 1, comprising:
an axle for transmitting the force of the motor of the vehicle toward a satellite of the front open differential mechanism;
a first switch for connecting and disconnecting the transmission of force going from the motor to the first differential mechanism; and
a second switch for connecting and disconnecting the transmission of force going from the motor to the front open differential mechanism.

26. The system corresponding to claim 1, further comprising a transfer case for inverting the spin of the wheels on one side of the vehicle relative to the wheels on the opposite side; wherein the said transfer case comprising:
a longitudinal axle that transmits the force of the motor of the vehicle to the first differential mechanism;
at least a first conical gear that is inserted axially to the longitudinal axle;
at least a second conical gear that connects perpendicularly to the first conical gear;
a transverse axle which supports the second conical gear where the said transverse axle connects to its corresponding power transmission mechanism and is supported by the side walls of the transfer case;
a switch placed on the transverse axle, for connecting and disconnecting the transmission of force directed to its corresponding power transmission mechanism; and
an additional switch placed on at least one of the components that transmit the force that goes from the first conical gear to the first differential mechanism.

27. The system of claim 26, further comprising a brake, placed on at least one of the components that transmit the force that goes from this latter switch to the first differential mechanism.

28. A vehicle, comprising a differential system that controls the transmission of at least the four wheels of a vehicle
the differential system comprising:
a first differential mechanism connected between free extremities of each axle of the wheels of the vehicle in which the free extremities of the axles are connected to planetary gears of the differential mechanism;
at least a power transmission mechanism is provided for each side of the differential mechanism in which the driving element of the power transmission mechanism is connected to the axle that is connected to the differential mechanism and the driven element to the axle without differential mechanism of the wheels on one side of the vehicle, in order to transmit force to the said wheels through the transmission medium of the said power transmission mechanism;
a freewheel unit is placed on every power transmission trajectory going from the differential mechanism toward its corresponding front wheel; and
at least one braking system for braking the wheels of the vehicle.

29. The vehicle, in accordance with claim 28, wherein said vehicle can be selected from the following group: cars, all-terrain vehicles, utility vehicles, cargo transport vehicles, and machinery with 4 or more wheels.
